(19) United States
(12) Patent Application Publication
(10) Pub. No.: US 2008/0092057 A1
(43) Pub. Date: Apr. 17, 2008

(54) Framework for creation of user interfaces for electronic devices

(75) Inventors: Paul K. Monson, Renton, WA (US); Michael J. Salamone, Redmond, WA (US); Eric Hesselgesser, Seattle, WA (US); Norman C. Hamer, Shoreline, WA (US); Srinivas R. Nutalapati, Bellevue, WA (US)

Correspondence Address: LAW OFFICES OF CHARLES W. BETHARDS, LLP, P.O. BOX 1622, COLLEYVILLE, TX, 76034, US

(73) Assignee: Instrinsyc Software International, Inc

(21) Appl. No.: 11/973,110

(22) Filed: Oct. 5, 2007

Related U.S. Application Data
(60) Provisional application No. 60/849,848, filed on Oct. 5, 2006.
(60) Provisional application No. 60/849,849, filed on Oct. 5, 2006.
(60) Provisional application No. 60/849,501, filed on Oct. 5, 2006.
(60) Provisional application No. 60/922,083, filed on Apr. 6, 2007.
(60) Provisional application No. 60/922,090, filed on Apr. 6, 2007.

(51) Int. Cl. G06F 3/00

(52) U.S. Cl. 715/744

(57) ABSTRACT

A user interface framework (UIFW) application is arranged and configured to facilitate rendering a display on an electronic device. The UIFW application comprises a skin file including features and screen layout information, the skin file associated with an application; a theme file, separate from the skin file, and including screen theme information associated with the application, and a skinning engine coupled to the skin file and the theme file and configured to provide data to facilitate the rendering the display in accordance with the skin file and the theme file. Methods include a method for designing a UIFW application, a method of creating a view, performed by a UIFW application, to facilitate rendering a display on an electronic device, and a method in a UIFW for changing a theme without restarting the electronic device.

### RELATED APPLICATIONS

This application claims the benefit under 35 U.S.C. Section 119(e) of the following U.S. provisional patent applications: Ser. No. 60/849,848 filed on Oct. 5, 2006 by Kath et al., entitled “System and Methods for Skin Creation”; Ser. No. 60/849,849 filed on Oct. 5, 2006 by Kath et al, entitled “Application Development Environment For Mobile Device Creation”; Ser. No. 60/849,501 filed on Oct. 5, 2006 by Kath et al, entitled “Framework For Building And Deploying A Mobile Device User Interface”; Ser. No. 60/922,083 filed on Apr. 6, 2007 by Monson, entitled “Application Design Framework For Mobile Devices”; and Ser. No. 60/922,090 filed on Apr. 6, 2007 by Monson, entitled “Skin Designer For Mobile Device”, which applications are hereby incorporated herein by reference.

### FIELD OF THE INVENTION

This invention relates in general to user interfaces and more specifically to methods, systems and apparatus for the creation of user interfaces, skins and themes for electronic devices, such as wireless devices, cellular phones, PDAs, MP3 players, streaming media players, and the like.

### BACKGROUND OF THE INVENTION

Wireless communication devices rely on sophisticated graphical user interfaces (UIs) to convey information at a glance to an end-user via icons, themes and wallpapers. Equipment manufacturers, network operators, etc. utilize the UIs for product branding as well as a means of conveying information about the operational state of the device. Equipment manufacturers, etc. spend time and effort to ensure the UI is visually appealing as well as intuitively easy to use.

The UI can be used for product and manufacturer differentiation. Equipment manufacturers typically sell the same device (make and model) to several different network operators. To differentiate the product for the various network operators, the equipment manufacturer often alters the UI, typically changing the background colors, themes, sound files, etc. End-users may also want to further customize and personalize their device, e.g., by purchasing or downloading background images, ring tones, and icons. These end-user customizations should be easily applied without adversely affecting the device functionality.

Additionally, equipment manufacturers often desire to use a base hardware platform to which hardware and/or software components and associated functionality is utilized/added for rapid device development and customization. Currently the presence of or removal of such plug-in components requires significant changes to the UI, as the UI is tightly coupled to the underlying application logic of the device.

At present, rapid device development and customization is hindered by the lack of a UI application design tools and user interface generation framework (UIFW), which provides the original equipment manufacturer (OEM) with a means of quickly designing, customizing and deploying a device UI.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, a high level block diagram of a User Interface Framework (UIFW) environment in accordance with one or more embodiments;

FIG. 2 depicts in a simplified and representative form, a high level component diagram of a User Interface Framework design tool environment in accordance with one or more embodiments;

FIG. 3 depicts in a simplified and representative form a block diagram of components within a User Interface Framework in accordance with once or more embodiments;

FIG. 4 depicts a class diagram for the Skin Engine Component of the User Interface Framework in accordance with one or more embodiments;

FIG. 5 depicts in a simplified and representative form an entity relationship diagram for the Element Hosting Architecture of the User Interface Framework as it relates to the User Interface design tool;

FIG. 6 depicts in a simplified and representative form a block diagram of the component customizations within a User Interface Framework;

FIG. 7A depicts in a simplified and representative form the components and processes of the User Interface Framework application development environment;

FIG. 7B depicts building and deploying components of the User Interface Framework design tool software;

FIG. 8 depicts in a simplified and representative form a block diagram of User Interface Framework application components when deployed on a end-user device;

FIG. 9 shows a flow chart of processes executed by the User Interface Framework Theme Manager as deployed on an end-user device in accordance with one or more embodiments;

FIG. 10A shows a flow chart illustrating representative embodiments of a method of modifying a Theme in response to an System Event Notification, or user-initiated Theme change as deployed in end-user device in accordance with one or more embodiments; and

FIG. 10B shows a flow chart illustrating a method of loading a theme from persistent storage and applying it to user interface on an end-user device in accordance with one or more embodiments.

### DETAILED DESCRIPTION

In overview, the present disclosure pertains to systems and methods for the creation, design, development, modification, deployment or management of User interfaces (UIs) including skins and themes for electronic devices.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs running on computers, e.g., workstations, personal computers, etc. or within embedded software or firmware running on or executed by processors, such as microprocessors within integrated circuits (ICs) including possibly application specific ICs. It is expected that one of ordinary skill, notwithstanding possibly significant effort and many design choices motivated by, for example, available time, current technology, and economic considerations, when guided by the concepts and principles disclosed herein will be readily capable of generating such software programs and instructions without undue experimentation. Therefore, in the interest of brevity and minimization of any risk of obscuring the principles and concepts according to the present invention, further discussion of such software and ICs, if any, will be limited to the essentials with respect to the principles and concepts of the various embodiments.

In many markets, rapid device development and customization is important and this may include creation, etc of one or more UIs that are device specific, which in turn can be improved by a UI application design tool and user interface framework (UIFW) and software tool set which provides interested parties, e.g., original equipment manufacturers (OEM), device suppliers, etc., with a means of quickly designing, customizing and deploying a device UI independently of the device's underlying application logic. The UI normally must reflect the device's hardware platform and software capabilities and should be testable independently of (i.e. via an emulator) and together with the application logic. In one or more embodiments, the UIFW can be integrated into a standard application development tool such as Microsoft's Visual Studio, Platform Builder and programming languages such as Visual C++ and XML; and the UIFW should support a standard device operating system such as Windows CE, and output memory efficient binary compiled format UIs (e.g. Binary FX (BFX)).

Network operators and end-users often desire to have the ability to tailor a UI for their own needs, e.g., via tools and wizards designed to support the resultant deployed device UI as provided by the device supplier, e.g., OEM. To support resource constrained wireless devices, the deployed device UI must have a small footprint. Additionally, the deployed device UI can dynamically reflect changes in the operational environment, which operational changes cause or result in a corresponding dynamic change of UI skin and theme appearance.

In accordance with varying embodiments the present disclosure discusses and describes systems and methods for development, etc. of a graphical application user interface for an electronic device, e.g., a portable electronic device. The system can include one or more of a skinning engine, an application engine, language support, an application adaptation controller, application data schema or language specific resources. In varying embodiments, systems and methods for defining a user interface layout, wherein the user interface layout data is decoupled from the associated application logic, are discussed.

In further discussions other embodiments of systems and methods are described, which are suitable to define a user interface layout in which control elements can be coupled to underlying application logic for emulation, debugging and testing purposes without object binding during a design phase or which are configured to parse a data independent user interface layout. In other aspects, systems and methods to compile and link a data independent user interface layout to its associated underlying application logic to produce a run-time device image. In some embodiments, systems and methods are arranged to deploy a user interface framework on an end-user electronic device.

In some embodiments, a toolbox of predefined libraries, tools, components, data objects, and reference layouts are arranged to provide for a user interface framework. In some embodiments, systems and methods are configured for generating one or more themes for association with a user interface layout.

In other embodiments, systems and methods are configured for displaying a run-time user interface layout generated by a user interface framework on a end-user portable device, where, e.g., the system includes a Run-time Skinning Engine; a Theme Manager; BFX Parser; Object Factory; Runtime Object Library; System Event Service; Localization APIs or Custom Themes. In some embodiments, methods for displaying and modifying a run-time user interface layout on an end-user device are provided, where the methods can utilize a Theme Manager, and an System Event Service.

1. User Interface Framework Overview

Systems and methods for the creation, design, development and management of skins and themes for portable electronic devices, collectively referred to as the User Interface Framework (UIFW), are presented as follows. The UIFW is comprised of design time and run-time components. More specifically included is UI application development environment, referred to as the ‘UIFW development environment and an end-user run-time environment including a Theme Manager.

Generally described, the UIFW development environment includes custom UI design software, libraries, tools, compilers, parsers, and wizards which allow application developers and UI designers to change the skin or layout of application screens in the device without modifying the underlying application logic and to change or modify themes for application screens. Often application program development is performed using a visual application programming suite, such as Visual Cafe™ from Symantec Corp., or Visual Studio™ from Microsoft Corp, such suites being specific to a particular operating system (e.g. Microsoft Window CE) and/or programming languages (i.e. C, C++, Java, etc). In one embodiment, the UIFW is designed for use in conjunction with Microsoft's Visual Studio Integrated Development Environment and for deployment on end-user devices running the Microsoft Windows CE™ operating system.

The UIFW development environment is comprised of custom UI design software, code libraries, tools, compilers, parsers, wizards, sample skin and theme layouts, custom UI objects and elements, for use in conjunction with the Microsoft Visual Studio™ integrated application development environment (IDE). The design tool component, referred to as the User experience Designer (UxDesigner) of the UIFW, is provided as a custom software application, including plug-in libraries and tools for Visual Studio. UxDesigner seamlessly integrates into the Visual Studio environment. In addition to the standard application development tools, languages, compilers, emulators and debugging tools available within the Visual Studio framework, the UIFW is a custom software application and toolset specifically for the development of application independent UIs for electronic devices.

More specifically, the UIFW development environment separates the underlying application logic of the device (i.e. device application logic) from the layout of the interface elements within the UI view. These elements can include such components as strings, layouts, images, sounds, animations, and videos. Separating the application logic from the layout allows the application to be easily customized during run-time to support such run-time customization, such as end-user language preferences.

Additionally, the device implementer may also specify themes which are changeable by the device end-user via a Theme Manager. These themes can include icons, images, color data, sound file locations, image files locations, images, theme specific application layouts, and reference to shared resources such as icons, images, sounds, animations, and videos. As deployed on the end device, when an application that uses the UIFW receives notification of theme changes, the UIFW automatically reloads theme sensitive elements by using the Theme Manager application programming interfaces (APIs) and updates the application screens to be consistent with the new specification.

In a sense, themes control the look and feel or user presentation of a device in the absence of a skin element or object that overrides the presentation as provided by the theme. For example, wall paper or background display colors, patterns, default fonts, face names, etc. are typically provided by a theme unless a font, button or other object is specified as part of a skin, in which case the specified font, button or other object will override or cover up the theme element. Themes and skins can be changed independently of each other.

1.1 User Interface Framework (UIFW)

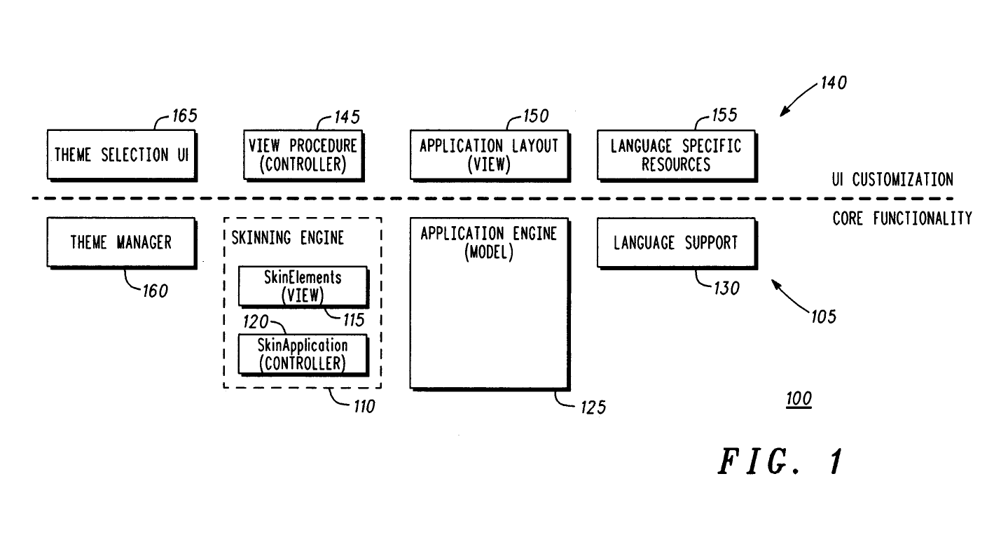

Referring to FIG. 1, a high-level block diagram of a User Interface Framework (UIFW) environment 100 will be discussed and described. The UIFW is further subdivided into two logical layers: the Core Functionality Layer 105 which contains the core device application logic independent of the UI; and the UI Customization Layer 140 which allows an application developer to create the user interface independently of the core application logic. The distinct separation of core application logic of the device from that of the user interface which will be deployed on the device, is central to the structure of the UIFW development environment. Separation of UI design elements from the device application logic facilitates end-user customizations, e.g., via the Theme Manager.

The Core Functionality Layer 105 is comprised of: a Skinning Engine 110; an Application Engine (Model) 125; a Language Support module 130; and a Theme manager 160. The underlying software code in the Core Functionality Layer does not change for different UI layout designs; it remains independent of the user interface. The Skinning Engine 110 provides a collection of UI components, shown as SkinElements View 115 that are assembled via a SkinApplication Controller 120 to create a user interface. It also provides most of the application in a data driven manner. The Application Engine (Model) 125 is the complete core device application without any user interface. UI specific changes to the Application Engine (Model) are not required within the context of a UI design effort. The Language Support module 130 provides the logic required to change the user interface language without requiring a reboot to the end-user device system.

The UI Customization Layer 140 is comprised of: View Procedure (Controller) 145; Application Layout (View) 150; Language Specific Resources 155; and theme selection UI 165. The UI Customization Layer is significantly smaller that the Core Functionality Layer 105, as it is specifically designed to be data driven. A goal of the UIFW is to provide tools which permit the creation of a complete device specific UI including application flow and event handling from layout data only. However, due to the wide variety of interface displays (e.g. screen size, color display capabilities, display matrix type, etc) it may be necessary to, on occasion, provide custom UI code in C or C++ for a specific display type or when implementing highly interactive U's. The Application View Procedure (Controller) 145 fulfills this role. In the context of Microsoft Windows CE, it is a callback that may be written in C or C++. The Application Layout (View) 150 specifies the UI elements and their relationships to the underlying core application as presented by the Application Engine Model 125. The Language Specific Resources 155 are specific to the language(s) as provided via the Language Support resources 130. Typically a network operator and/or OEM will jointly determine which languages will be implemented on a particular device, and thusly affect this component.

A goal of the UIFW development environment is to decouple UI layout and the data associated with each UI element from the device application core functionality, resulting in a data driven UI application which may be easily modified at run-time through changes in operating system variables and/or user context sensitive environments. More specifically, with reference to FIG. 1, the User Interface layer is comprised of the View Procedure (Controller) 140, the Application Layout (View) 150, the Language Specific Resources 155, Theme selection UI 165. Within the UIFW, a user interface (i.e. UI Layout) is a file comprised of components and elements created using the Skinning Engine 110. The UI Layout is designed utilizing the custom design tools provided via UxDesigner, as well as using the standard tools available within the Visual Studio IDE. A compiler, referred to as FX Compiler, compiles the UI Layout formats (.FX files) and commands into Binary FX (BFX) code; the compiled BFX files are embedded into DLL (Dynamically Linked Library) files as binary data resources. The resultant skin resources and view procedure are executed on the end-user device by the skin engine to provide the user interface skin for the underlying device core application. Similar functions are performed by the theme manager 160 and theme selection UI 165 to provide resultant theme resources, etc that when executed on the end-user device by a theme manager provide a user interface theme for the underlying device core application.

More specifically, a UIFW application using the skinning engine includes the following four parts: the Skinning Engine 110; the Application Engine (Model) 125; the Application View Procedure (Controller) 145; and the Application Layout (View) 150.

1.2 UIFW Design Tools Overview

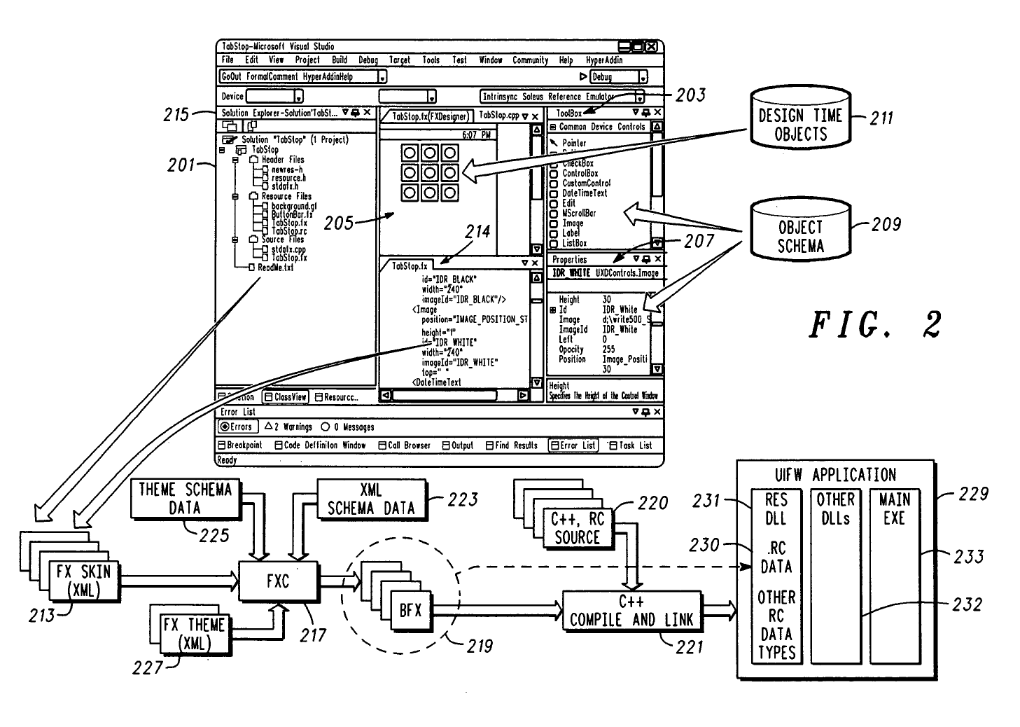

Referring to FIG. 2, a high-level component diagram of the UIFW design tool environment is shown within the context of a Microsoft's Visual Studio application development environment 201. At design time the device implementer can edit the FX skin XML 213 that represents device screen skins which may be different for different applications or may be the same for all applications on a given device. The custom UIFW design tools provided to do this allow the implementer to drag and drop objects from the toolbox 203 onto the device surface 205 to visually create the device interface skin appearance. After dropping objects onto the design or device surface, the implementer can change the properties of the objects by changing values in the property grid 207.

What appears in the toolbox and the properties of objects after they are placed on the design surface are both controlled by the object schema 209 as defined in a UIFW design tool specific XML document. Also, in order for the design surface to show the implementer what the skin will look like on the device, design-time objects 211 are provided with the object schema. These design-time objects are implemented in C++ and described in the object schema.

The FX skin file 213 may appear side-by-side with the design surface 205 in the design tool. The implementer may change either an FX text file 214 by editing the text or manipulate the FX skin file 213 visually by moving design-time objects on the design surface and modifying properties in the property grid 207. In the end one or more skin files 213 that represent a screen skin for an electronic device are provided

All of the files included in an application project are shown in the project view 215. This includes .cpp, .h, .rc, and .fx files. The .cpp files are compiled in .exe files and .dll files. The .fx file(s) are compiled using the FX Compiler 217 into binary FX files (BFX) (compiled skin files) 219. The XML or skin Schema data (data similar to the object schema 209 as defined in the UIFW design tool specific XML document) is used to authenticate or validate the BFX files as produced by the FX compiler 217. Validation at compile time simplifies run time operations and processes. BFX files are packaged together with images, sounds, animations, videos, icons, strings, and application specific data in one file. In one embodiment, the BFX file 219 becomes RCDATA within .RC files 230, as indicated, after being packaged via resource compiler (C++ compile and link 221) in a resource only dynamically linked library (DLL) 231 along with images, sounds, animations, videos, icons, strings and application specific data 220 (provided with the UIFW design tools). English strings are included in the base skin by default. For each skin, additional resource only DLLs 232 with strings, images, sounds, animations, videos, and icons are created for each language, in addition to English, which is to be supported at run-time. Additionally a Main Exe 233 is provided. The collection of Resource DLL with embedded skin data in the form of RC Data, other DLL, and Main Exe comprises a UIFW Application 229. It will be appreciated that a plurality of Applications 229 along with theme information may be included in one device image.

While not specifically shown, device implementers using a theme editor can also choose and edit FX Theme files 227 in a similar and independent/separate fashion, separately compile these via the FX compiler 217, and validate the results with the Theme Schema data 225 to provide additional BFX data files (compiled theme files) that are consumed by a Theme Manager (discussed below) at runtime. The Theme Editor takes an XML schema document or data (analogous to 209) that describes all of the required theme elements for a theme on a particular device. This means different devices can have different sets of theme data. The theme editor displays the properties of a theme that can be edited in one pane (icons, images, color data, sound file locations, image files locations, images, and theme specific application screen layouts) and preview of what the theme looks like applied to a specific sample screen on a different pane.

From above and in view of further discussions, a system and method of designing a user interface framework application which is arranged and configured to facilitate rendering a display on an electronic device has been described. In one embodiment, the method comprises providing one or more skin files that represent a screen skin for an electronic device, providing one or more theme files that represent a screen theme for the electronic device and separately compiling the skin files and the theme files to provide compiled skin files and compiled theme files; and compiling and linking the compiled skin files with resources to provide an image that when run on the electronic device will facilitate rendering the display in accordance with the skin files and the theme files. In various embodiments, the providing the one or more skin files further comprises providing skin files for all screens associated with an application on the electronic device and can further comprises providing skin files for each application on the electronic device.

Providing one or more skin files 213 can include selecting objects from a menu, editing properties of those objects, and previewing the objects to provide the one or more skin files. In some instances, the possible objects and properties thereof can be defined by an object schema 209 that is predefined or separately edited and thus defined. Providing one or more theme files can further comprise similarly selecting theme elements, editing the theme elements, previewing the theme elements, etc.

In various embodiments, the method further comprises separately validating the compiled skin files and the compiled theme files, prior to compiling and linking the skin files with resources. Separately validating the compiled skin files and the compiled theme files, respectively, can utilize skin schema data 223 and theme schema data 225. Compiling and linking or embedding the compiled skin files to provide an application image can further provide an image wherein data files are separate from dynamically linked libraries and run time executables.

Some advantages of the UIFW development environment and custom design tools are: the ability to layout and initialize controls not supported by the dialog editor; the ability to support different device resolutions without modifying code; the ability to support different orientations; and the ability to support different layouts for different languages without modifying the code. Some examples of changes to a UI layout design that would be considered minor in time and effort include: change wallpaper(s); change ring tone(s); change startup/shutdown screens; change message text; and change basic theme data. To change wallpapers or ring tones the files must be added to the OS image, and the manifest for the file type. The manifest filters the file system so that when the end-user browses for ring tones or wallpapers they don't see every file in the file directories or hear inappropriate system sounds.

Some examples of changes to an existing UI design that would be considered moderate in time and effort include: change layout of application(s); change order of dialogs in an application; add, remove, or change menu items; change/add language support; and changes to the user-interface adaptation code. To change the layout of an application, change the order of the dialogs, or change menus the visual layout tool is used to re-arrange the layout. Another option is to directly manipulate the layout, dialog order, or menu data in XML format. Tools are provided to preview the changes and to allow the implementer to quickly make, test, and validate changes to the user interface layout.

To add language support locale specific data must be translated. This is done by using the localization tools to create a new resource only .dll with the new string resources. After the resources have been localized, the language dll is added to the OS resources so that language selection applet knows that it is available.

Some examples of changes to an existing UI design that would be considered major in time and effort include: a new, first time UI design and layout; and any major changes to the functionality of the core applications such that the user experience must be changed in a way that isn't supported by changing the menu structure or the application layout data necessitating a change to the application engine. Major changes can require modification or replacement of the View Procedure (Controller) module 145, which then can require complete testing and debugging at the core application programming level.

1.3 UIFW UI Application Components

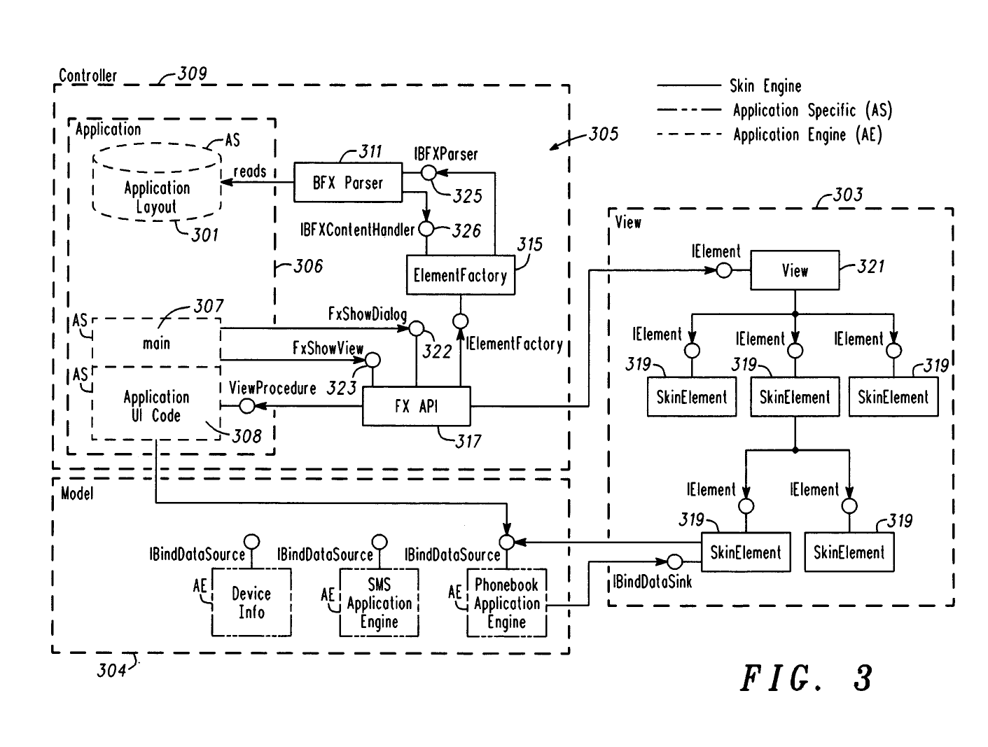

Referring to FIG. 3, a block diagram of components within a User Interface Framework will be discussed and described. FIG. 3 illustrates additional details pertaining to components, some of which are analogous to those presented in FIG. 1. It will be noted that much of this discussion focuses on skin creation. Application Layout data storage 301 (analogous to 150) is used to dynamically generate various objects in the View 301 (analogous to Application Layout (View) 150) in FIG. 3. An Application Engine (Model) 304 is analogous to the Model 125 in FIG. 1. A Skinning Engine 305 (similar to skinning engine 110) comprises a parser 311, element factory 315, FX API 317, and the view 303. An application 306 includes the application layout 301 plus a main exec 307, and Application UI code 308 (analogous to view procedure controller 145). A controller 309 includes the application 306 and most elements of the skinning engine 305.

On completion, a fully defined UI Layout and run-time device application includes the following UIFW components: FX API Library 317; Element Factory 315; Parser (also referred to as a BFX Parser) 311; View Procedure 318; Layout Data (also referred to as FX data) (application layout 301); and one or more Skin Elements 319, which are described in more detail as follows. A UI interface also includes a theme or theme screen for each application. In a fashion that is similar to and will be appreciated by those of ordinary skill given the specifics discussed herein, a theme can also be provided at runtime. Generally, a theme manager (not specifically shown) utilizes, with appropriate calls, etc., the parser 311 to read and parse theme files (stored in Application layout 301 as separate files or stored in other similar storage as BFX theme files) to facilitate construction of a theme or theme screen for any display on the user device. This can include storing theme data or files in common storage so that multiple processes on the user device can access the theme data.

1.3.1 Skin Application Object

Referring to FIG. 3, when created for a device utilizing an operating system, e.g., a Windows based operating system such as Windows CE, a UIFW application creates a View object 321 in its main procedure 307 by calling FxShowDialog 322 or FxShowView 323. The FX API 317 is a set of functions exported from a DLL. The FX API 317 creates or forms the ElementFactory 315 to read the Application Layout 324, and, responsive to the Application Layout 324, creates each of the Skin Elements 319 to create the View 303. Once the View 303 is loaded, the FX API 323 calls Initialize on the root Element (View 321), which initializes any additional data or windows required for the operation of the View and it's children (Skin Elements 319). At times it may be desirable to start views with modal, modeless, or notification styles; which is supported by adding these styles to view elements in the skin files (Application layout 324).

1.3.2 Element Factory Object

The ElementFactory 315 object registers callbacks 325, 326 with the Parser 311. As data is read from the application layout storage 324 and parsed, the ElementFactory object is called back with information about each element and its attributes. For each element, the ElementFactory creates a SkinElement object 319 and sets its properties, via the FX API 317, using the values in the data attributes (Application layout 324), by calling IElement (:SetAttribute) 327. The new element is added as the child of the current element if one exists, and the current element is set to the new element. When the end attribute call back is called, the current element is set to be the parent of the newly created element. Tracking the current element in this way allows the Skin Element Object hierarchy to be reconstructed in the device memory.

1.3.3 Parser

The Parser 311 is a Binary FX (BFX) parser that provides a SAX (Simple API XML) like parser for skin data. BFX format is preferred over regular XML to reduce the number of runtime string comparisons resulting in improved run-time performance. The Parser is specifically designed to manipulate UIFW data as described in a UI layout (also referred to as a ‘skin’). The Parser client registers callback with the parser that are called back for each BFX element. The callback also provides the Parser client with the attributes of each element. The BFX parser also notifies the client of the end of an element. Parser elements can be nested. This allows the Parser client to infer a user interface hierarchy from the stored data.

At design time, UI elements are described in XML (.FX) format. Referring to FIG. 2, once the UI designer completes the design project and is ready to build the UI and the application for deployment on an end-user device, a compiler, shown as the FX Compiler (i.e. FXC 217), compiles the skin file data into a binary format XML which is referred to as BFX. A compiling and linking process (i.e. C++ Compile & Link) then takes the application logic (i.e. C++RC Source) and creates an application image 229, for deployment on an end-user device. The run-time application image embeds skin data (contains BFX files) which are parsed by the UIFW device run-time application to build the Element Objects when invoked by an end-user device.

The BFX format is preferred for embedded devices because it provides a good level of compression; i.e., size can be reduced to as much as 20 percent of the original document size. The footprint of the BFX parser (by retaining only basic functionality and avoiding runtime interpretation or authentication activities) can be much smaller than general purpose parsers, such as the XML reader provided in Microsoft's Visual Studio IDE. BFX also prevents casual users from tampering with UI Layouts on a device. BFX files may be digitally signed. By authenticating BFX files before loading them, unauthorized changes to the UI Layout can be prevented.

1.3.4 View Procedure(s)

View Procedures are Skinning Engine callbacks implemented by the device application developer. This enables the device application to handle windows messages; and command events. If the device application code needs to modify individual controls it can handle the WM_VIEWELEMENT message to get the root Skin Object Element and perform operations on the Skin Object tree.

1.3.5 UIFW UI Application Components Conclusions

From above a system and methods performed by a user interface framework application have been described. The method creates a view to facilitate rendering a display of an electronic device where the user interface framework application is installed and comprises calling one or more functions from a dynamically linked library (DLL), forming, responsive to the calling, an element factory, reading separate layout information and data from storage with the element factory, and creating a plurality of skin objects responsive to the separate layout information and data, wherein the plurality of skin elements are associated with the view to facilitate rendering the display of the electronic device. The calling can further comprise calling an API (FX API) which is a set of functions exported from a DLL. In some embodiments, the reading further comprises registering callbacks with a parser and reading the separate layout information and data using the parser. The method in other embodiments further comprises parsing the separate layout information and data using the parser as the reading occurs and forwarding information to the element factory regarding each element and data attributes of each element. The creating a plurality of skin elements can further comprise creating a skin element corresponding to each element and setting properties for each skin element using values of the data attributes of each corresponding element. Additionally in some embodiments, the method further comprises reading theme files from the storage, the theme file separate from the layout information and data, where the theme files can be used for providing a theme for the rendering the display on the electronic device.

2. Skin Elements

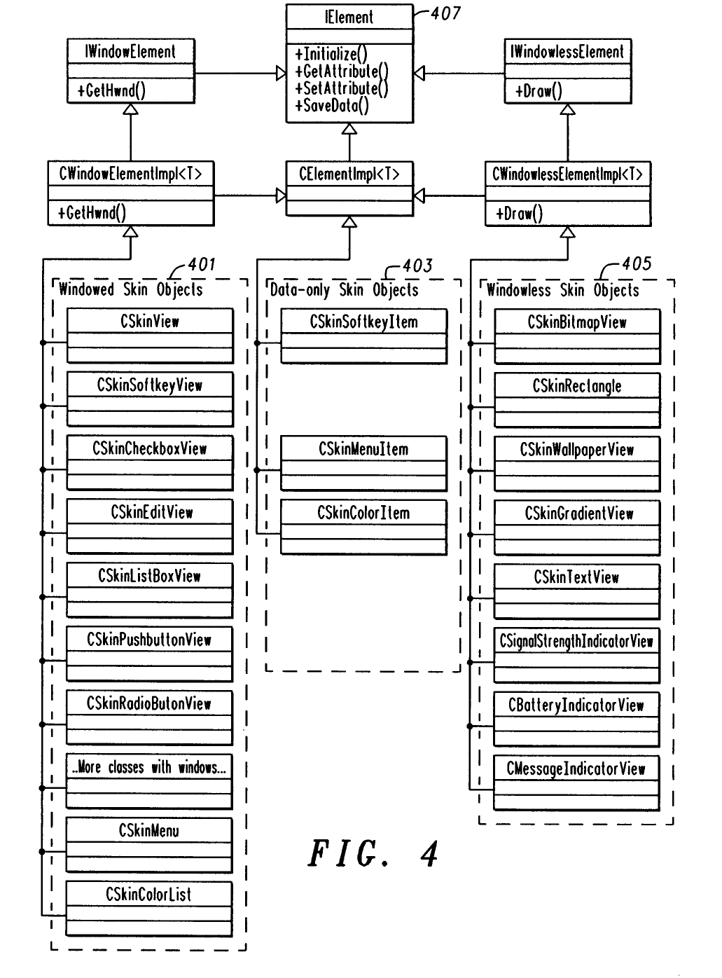

With reference to FIG. 4, there are three types of skin elements: 1) Windowed 401; 2) Data-only 403; and 3) Windowless 405. Referring to FIG. 4, a class diagram is presented for some of the objects and elements utilized by the skin engine. The class diagram groups some of the more commonly utilized objects and skin elements according to their type (i.e. Windowed, Windowless or Data-only).

More specifically, Windowed Elements create an associated window element and set it's data based on the control's properties (see FIG. 2, 203 Common Device Controls). Windowless Elements are used to automate drawing of the parent window without using additional window resources. Data-only Elements are used to store data that is used by parent objects, or is non-visual like accelerator table information. The skin information may contain information that binds properties on Elements to a data source. For example, the network name text control's Text property might be bound to the DeviceSettings element's network name text field. This allows the UIFW Skinning Engine to provide the default implementation of many aspects of the UI Layout without requiring additional code. Table: SKIN ELEMENTS shows an extended list of objects and implementing interfaces. It will be appreciated that this table as well other tables herein is exemplary only, not necessarily comprehensive, and may be expected to evolve with specific applications or over time.

TABLE
Skin Elements

| | Implements | |
|---|---|---|
| Object | Interface | Description |
| View | IWindowElement. | Represents the main |
| | | window that appears as the |
| | | main user interface |
| | | window. It is the main |
| | | application screen. |
| Panel | IElement | A container element that |
| | IWindowElement | hosts Window and |
| | | Windowless Elements |
| Softkeys | IElement | A container element that |
| | IWindowElement. | hosts individual Softkey |
| | | elements. Provides an |
| | | abstraction for the Softkey |
| | | control. |
| Softkey | IElement | A single softkey element. |
| Image | IElement | draws an image (e.g. |
| | IWindowlessElement | BMP, JPG, GIF, PNG) on |
| | | the surface on a View. |
| Rectangle | IElement | Draws a solid color |
| | IWindowlessElement | rectangle on a View. |
| Menu | IElement | A container element that |
| | IWindowElement | hosts individual MenuItem |
| | | elements. Provides an |
| | | abstraction for an object |
| | | such as PhoneList control. |
| MenuItem | IElement | A single menu item on a |
| | | menu list. |
| Wallpaper | IElement | Paints the user selected |
| | IWindowlessElement | wallpaper on the View. |
| Gradient | IElement | Creates a gradient. |
| | IWindowlessElement | |
| Checkbox | IElement | Creates a checkbox. |
| | IWindowlessElement | |
| GenericWindow | IElement | Hosts a standard windows |
| | IWindowElement | control by classname. |
| Text | IElement | Paints text on a View. |
| | IWindowlessElement | |
| MultiEdit | IElement | Hosts a MultiEdit control |
| | IWindowElement | in the View. |
| Listbox | IElement | Creates a listbox in the |
| | IWindowElement | View. |
| Pushbutton | IElement | Creates a push button in |
| | IWindowElement | the View. |
| Radiobutton | IElement | Creates a radio button in |
| | IWindowElement | the View. |
| Scrollbar | IElement | Creates a scroll bar in the |
| | IWindowElement | View. |
| Meter | IElement | Creates a meter in the |
| | IWindowElement | View. |
| SingleLineList | IElement | Hosts a single line list |
| | IWindowElement | control in the View. |
| Animation | IElement | Draws an animated image |
| | IWindowElement | on a View. |
| Indicator | IElement | Displays a data-driven |
| | IWindowlessElement | status indicator in the |
| | | View. |

The controls as defined within for the specified UI Layout are accessed via the IElement interface 407. By using the GetAttribute and SetAttribute methods it is possible to control all of the essential properties of the underlying object. The UIFW development environment implements and generally uses the following Skin Elements to create a user interface design.

2.1 Skinning Engine Interfaces

All design-time data is stored in XML format (i.e. .FX files). XML elements represent C++ objects with properties. The Skinning Engine (120, FIG. 1) takes serialized layout data and creates the UI layout from the FX data. The UIFW design tools uses and creates data objects in the Visual Studio design space, and communicates with the associated Application Engine Model 125 through window commands. The Application Engine logic is typically written in a programming language such as C, C++, Visual C++, or other such programming language. The UIFW automatically generates the appropriate code to associate with a specific element in the layout. At compile time, the XML layout schema is converted into binary XML files (i.e. BFX) which are then compiled and linked to create a run-time application 229 for the end-user device.

To create the UI Layout having control elements at run time, the Skinning Engine 305 implements and/or uses the following interfaces, some of which are explicitly shown in FIG. 4.

Referring to FIG. 3 as well as FIG. 4, the FX API 317 is used to start the Skinning Engine 305 where in an application's main procedure 307 calls FxShowDialog 322 or FxShowView 323. When a language change or orientation change occurs, the Skinning Engine automatically revises the layout view and reloads resources for the active view. For views that are not active, the view will be marked as dirty and a re-layout will occur the next time the view is activated. The UIFW application developer has the option to override this behavior. The Table: FX API shows the methods implemented by this API.

TABLE
FX API

| Functional | | |
|---|---|---|
| Group | Method | Description |
| | FxInitialize | Initializes the Skin Engine |
| | FxShowDialog | Creates a modal View from a BFX |
| | | resource |
| | FxShowView | Creates a modeless View from a |
| | | BFX resource |
| | FxShowMenu | Shows a menu created from a BFX |
| | | resource. Menu layout may contain |
| | | numbering, icons, and animations. |
| | FxFindElement | Finds a Skin Object Element in |
| | | the View tree. A callback is |
| | | needed for UI code to program- |
| | | matically determine if each tree |
| | | object is a match |
| | FxFindElementFromID | Finds a Skin Object Element in |
| | | the View tree based on the ID |
| | | assigned in the FX file. |
| | FxGetRootElement | Given an element in a tree finds |
| | | the root element of that tree. |
| | FxEnumElements | Enumerates each element in the |
| | | tree and performs a callback to |
| | | a user specified method for each |
| | | element. |
| | FxEndDialog | Terminates a Modal View. |

The IFxObjectFactory interface (not specifically shown) creates a skin element from a numeric id or ProgId. It also provides a method for loading a view from a resource. The Table: IFxObjectFactory shows the methods for this interface. Like all COM interfaces, this interface inherits the methods for the IUnknown interface.

TABLE
IFxObjectFactory

| Functional | | |
|---|---|---|
| Group | Method | Description |
| Factory | CreateInstance | Creates an element |
| | | from a CLSID |
| | CreateInstanceFromProgID | Creates an element |
| | | from the ProgID |
| | CLSIDFromProgID | Gets the CLSID from |
| | | a ProgID |

The IElement interface is the primary interface of all objects created by the SkinApplication object from ISkinFactory. The Table: IElement shows the methods for this interface by functional grouping.

TABLE
IElement

| Functional | | |
|---|---|---|
| Group | Method | Description |
| | Initialize | Called when it's time to create element |
| | | resources like windows, and controls. |
| | GetAttribute | Gets an attribute of the element |
| | SetAttribute | Sets an attribute of the element |
| | SaveData | Saves the data to the model |

The IWindowlessElement interface is implemented on an IElement control if the control is a windowless control. The Table: IWindowlessElement shows the methods for this interface by functional grouping. Like all COM interfaces, this interface inherits the methods for the IUnknown interface.

TABLE
IWindowlessElement

| Functional | | |
|---|---|---|
| Group | Method | Description |
| Drawing | Draw | Paint the element in the rectangle. |

The IWindowElement interface is implemented on an IElement control if the control creates a window. The Table: IWindowElement shows the methods for this interface by functional grouping. Like all COM interfaces, this interface inherits the methods for the IUnknown interface.

TABLE
IWindowElement

| Functional | | |
|---|---|---|
| Group | Method | Description |
| Drawing | GetHwnd | Get the HWND associated with this element. |

The View Procedure allows the application writer to customize the behavior and appearance of views and controls.

2.2 Element Hosting Architecture

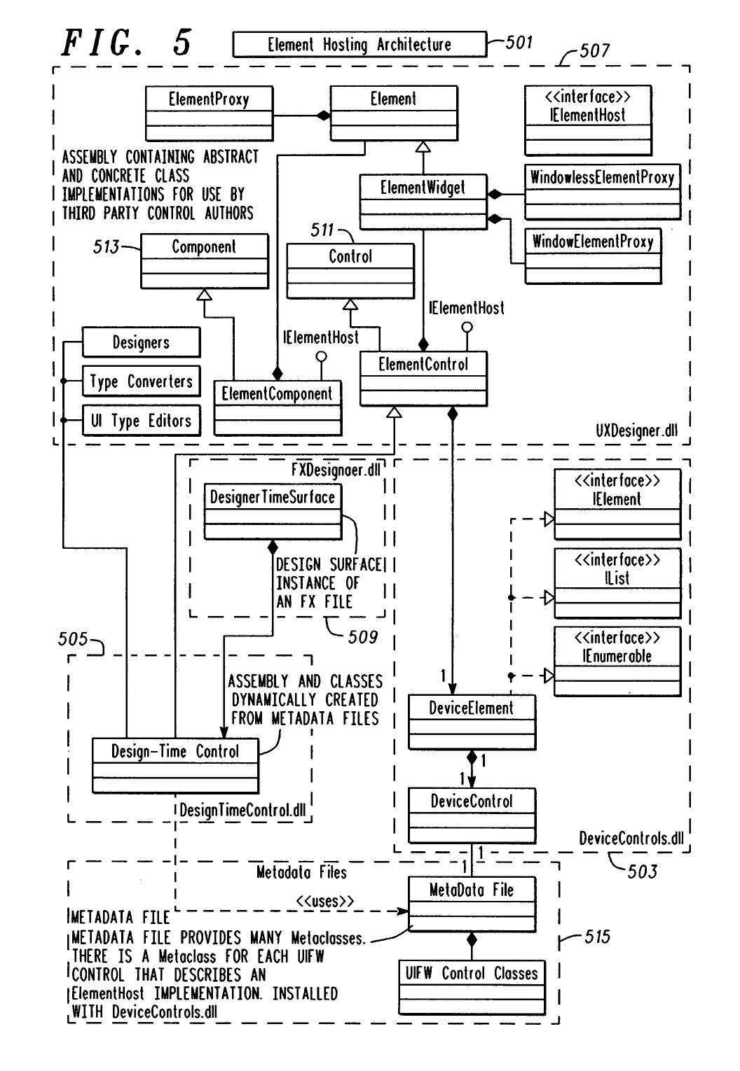

Referring to FIG. 5, the inter-relationships between the UIFW development application components are shown. The element hosting architecture 501 is presented by way of an example Design Time Surface instance of an FX File for a fictional device, which utilizes the UIFW control library (DeviceControls.dll 503) and a set of wrapper design-time controls (i.e. DeviceControlsDesignTimeControls.dll 505). The Design time controls are presented to the user using the Visual Studio Toolbox UxDesigner 507. For each UxDesigner:Element, there is a one-to-one relationship between the UxDesigner:Element and DeviceControls:DeviceElement (i.e. DeviceControls.dll). Both the DeviceFxDesigner.dll 509 and the DesignTimeControls.dll use the custom, dynamically created assemblies and classes within DeviceControls.dll. The UxDesigner project management tool installs the required DLLs as specified during a project definition and initialization phase. Thus, the UIFW provides application specific run-time code for use at design time to provide and facilitate the emulation of run-time behavior during the UI design process. The DeviceControls.dll, DesignTimeControls.dll, FXDesigner.dll and UxDesigner.dll are desktop implementations. The DeviceControls.dll is also built for the device.

More specifically, the purpose of the element hosting architecture is to leverage UIFW run-time code at design time and to provide run-time behavior for UIFW controls during the design process. The element hosting architecture facilitates this by providing ElementControl 511 and ElementComponent 513 wrapper classes, which are required so that the IDesignerHost can use them on the design surface. These classes implement IComponent by inheriting from the Control and Component classes implemented by the .NET Framework. These classes allow the element to expose design-time features that are implemented by the .NET Framework.

For UIFW window elements, a .NET control wrapper is created such that the wrapper has a transparent window and delegates the design-time presentation of the control to the contained UIFW element. The UIFW element delegates the presentation to the contained UIFW control. The .NET control wrapper exposes the .NET design-time support to the user by associating the control to custom designers, type converters and type editors.

Several classes are implemented specifically for Control Authors, namely IElementHost; IElementControl; ElementComponent; and ElementControl. IElementHost is an interface declaring the common properties and methods for hosting a UIFW components that implements IElement, IList and IEnumerable. A design-time control must implement IElementHost to use UIFW controls with FxDesigner.

IElementControl inherits from IElementHost and provides common properties and methods to manipulate a UIFW control. The ElementComponent class is used to host an element that does not implement any visual behavior. The ElementControl class is used to host a window type element.

3. UIFW UI Control Building Blocks

The UIFW enables customization of many aspects of the standard user interface as provisioned by the run-time operating system services. In particular, when configured to operate on a Microsoft Windows CE device, the UIFW customizes parts of the Windows CE OS to allow the run-time Theme Manager to control the appearance of standard controls and dialogs and to customize their appearance.

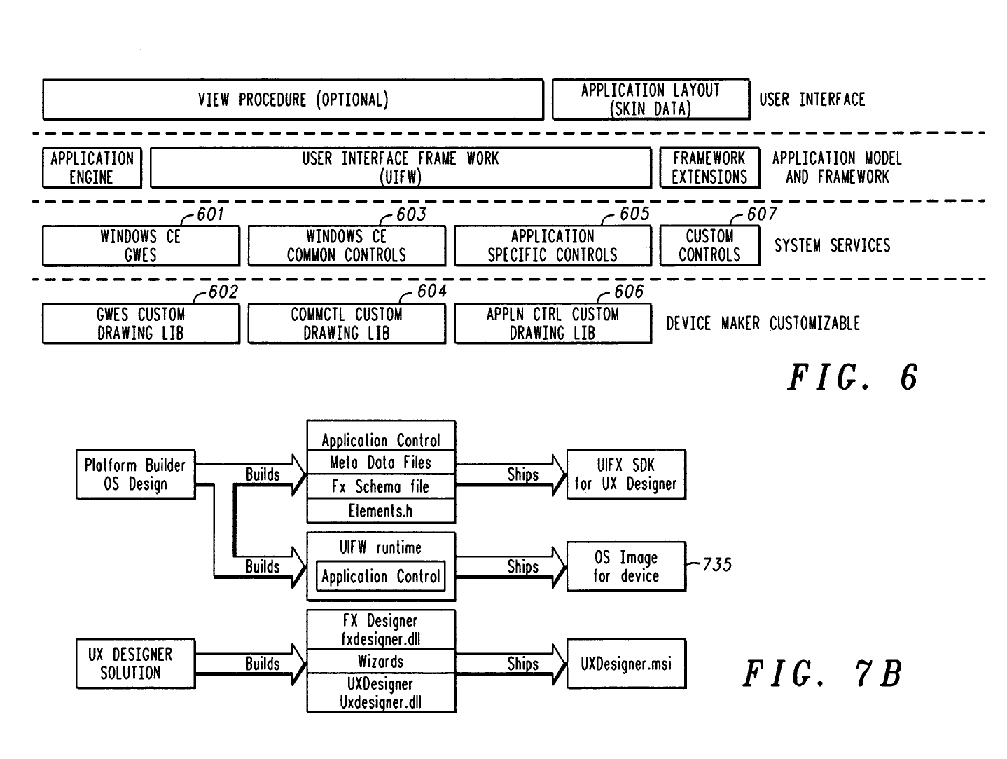

In particular, with reference to FIG. 6, the following System Services interfaces may be modified at build-time to facilitate UIFW customization run-time capabilities namely: the Windows standard control (GWES) 601, 602; the Windows common controls (CommCtrl) 603, 604; and Application Specific Controls 605, 606. OEM specific customizations 607 are also shown, but such customizations do not typically override or replace standard operating system controls.

The UIFW also facilitates customization of user interface elements at run-time, such as: system colors; startup screen; shutdown screen; logos; language; background wallpaper; color scheme; welcome text; banner text; user defined shortcut key(s); menu style; screen saver; and icons.

3.1 Windows Specific Customizations

The UIFW Theme Manager facilitates the customization of the appearance of the following Windows CE standard controls (GWES): Button (push, radio, check, groupbox); Combo Box; List Box; Scrollbar; and Static, for example. When deployed on the end-user device, the UIFW Theme Manager may apply colors and other resources to the standards GWES resources seamlessly. The UIFW Theme Manager also facilitates customization of some of the following Windows CE common controls (CommCtrl): Header control; Progress bar; Rebar; Tab control; Toolbar; Trackbar; TreeView and Up-down control, for example.

3.2 Custom Controls and Reference Implementations

To facilitate the rapid development and deployment of UIs for portable electronic devices, a library of pre-defined UIFW controls is provided (i.e. DeviceControls.dll 503 and associated Metadata Files 515). Included in this library are controls specifically designed for portable cellular and wireless devices, such as cell phones. The UIFW provided custom controls provide the UI designer a set of tools, as well as reference design layouts, to be used as building blocks in embedded device development.

Many of the UIFW custom controls are designed to support specific types of device, such as an end-user device with limited hardware capabilities such as few keys, no mouse, or without a touch screen for example. Additionally, the UIFW provides tools within the UxDesigner toolbox which the UI designer may use to further customize the provided UIFW controls.

The drawing and input handling of the following UIFW controls can be customized at build time: Multitap/Predictive Text Edit Control; Softkey Control; List Control; Menu Control; MessageBox dialog; Volume meter control; Notification Balloon Control; Single-Line Listbox; and Animation control, to name a few.

The UIFW also provides reference implementations for many of the following Windows CE replaceable components including: MessageBox; OOMUI; Non-client drawing, and DialogBox to name a few. An example UIFW reference application is PhoneList, which is implemented for the sample application Little Dialer, included within the UIFW component libraries.

In particular, the UIFW MultiEdit Control enables various end-user input modes, including: Multitap character entry; Symbol entry; Predictive text input; Shift states and input modes (ABC, Abc, abc); Bopomofo, Pinyin, and Stroke entry for Chinese characters, to name a few. MultiEdit is designed to accept 1 to n different input plug-ins including language character support, to provide advanced language input support. An example plug-in is T9 provided by AOL/Tegic for predictive text and Chinese character input.

The UIFW Softkey Control displays on screen soft key buttons that are associated with hardware keys. The location on screen of the soft key UI elements and the hardware keys they are associated with can be defined by the OEM. Softkey control can also be customized to handle different numbers of buttons as well.

In the context of a cell phone, the most commonly utilized reference control is the PhoneList. PhoneList is an example of the UIFW List Control. List Control extends the standard Windows CE Listview control and is used by UIFW applications to provide a consistent look and feel to the user interface.

The UIFW List Control extensions, available in PhoneList, provide one or more of: custom highlighting; selected item may be bigger than unselected items; animate of selected item icon; marquee scrolling of text for selected item that doesn't fit; automatic spacing of icons in icon view with a text descriptor shown at top or bottom; and alpha blending with wallpaper image, to name a few such extensions available when using the design tools described herein.

4. Creating a UIFW Application and Layout

4.1 UIFW Application Development Environment

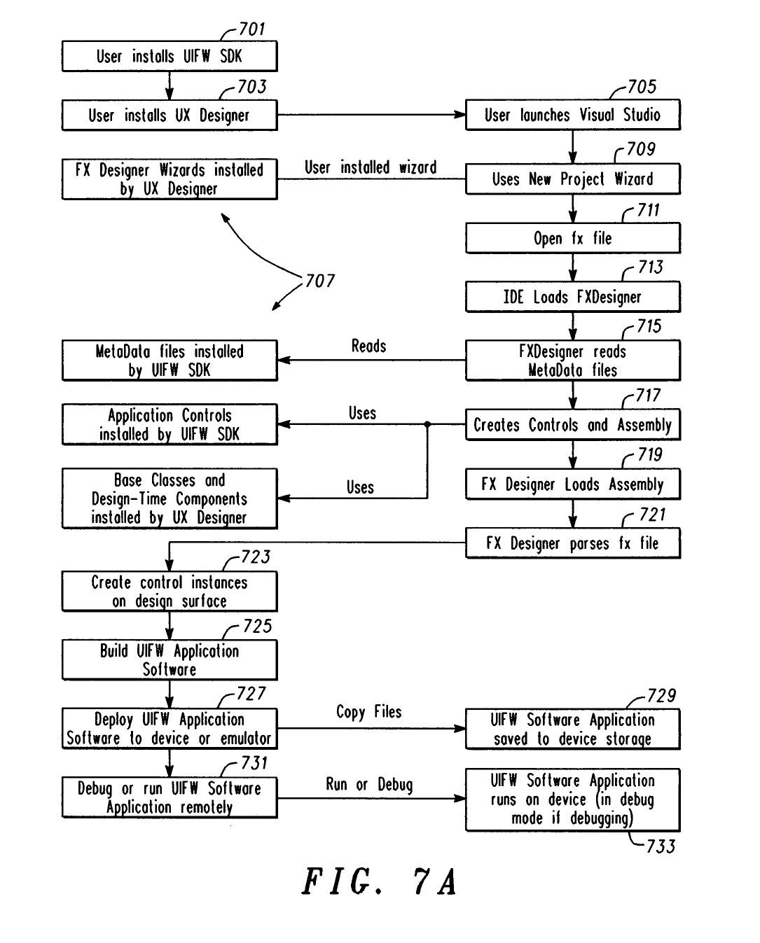

The UIFW application development environment consists of several software components and applications which installs and runs within the Microsoft Visual Studio IDE. Utilizing the design time tools available in Visual Studio, together with the custom UIFW application and tools, a UI designer can create an end-user device application in the form of a binary run-time device ready image. FIG. 7A shows the UIFW components as deployed within Visual Studio, as well as the components and data files installed to facilitate the creation of a UIFW run-time application. FIG. 7B depicts the steps and processes required to build and deploy components of the UIFW to create the UIFW design time application development environment, and to build and deploy a UIFW run-time OS image for an end-user device.

More specifically and referring to FIGS. 2 and 7A, the UIFW application development environment includes the UxDesigner, which provides a visual design toolbox, wizards, design-time classes and components to support design time representation of UIFW controls. The visual designer is intended to support VC++ application writers creating applications and for UI designers creating UI layouts for applications to be deployed on various types of portable electronic device platforms. Wizards are provided to help UI designers create new UIFW projects, associated UI description files (i.e. FX files), and UIFW controls.

The UIFW application development environment defines the desktop application environment. As the UIFW is used in conjunction with Microsoft Visual Studio, this environment must be installed on the host application computer prior to installing the UIFW 701. A UIFW project management tool, called UxDesigner, is provided to manage all UIFW projects and UI Layout definition files (i.e. FX files). Each desktop build of a control class is described by a metaclass, associated FX Schema file, and associated element header file (i.e. commonly called .h files). The element header file contains the defined values for the elements and attributes required by the controls, and the FX Schema file contains the schema for validating the controls specified in a FX file.

More specifically with reference to FIG. 7A, after UxDesigner is installed 703 and Visual Studio is launched 705 on an application development computer, the UIFW development environment runs to install core FxDesigner and UxDesigner utilities, components, and wizards within the Visual Studio IDE 707. The UxDesigner component is responsible for managing FX projects and files at design-time and builds is implemented in UxDesigner.dll. The UxDesigner provides the New Project and Add New Item wizards. UxDesigner component creates the design-time classes that are specified in metadata, the image SDK and other utilities. The FxDesigner is the visual design surface that is used to represent the User Interface described by the FX Files. There is one instance of the FxDesigner for every instance of an FX File.

After launching Visual Studio IDE 759, the user can use the New Project wizard to create an application project 709. The project will contain a preconfigured FX file and platform configuration. When the UI designer opens the FX file 711 for the first time, the IDE loads the FxDesigner package 713. The package will consume the metadata files 715 in the platform designer directory specified by the platform configuration and create the control types in an assembly 717. The metadata may reference design-time classes and objects implemented in the UxDesigner.dll. The FxDesigner will then load the assembly. The FxDesigner parses the FX File 721 to create instances of the controls on the design layout surface 723.

The UxDesigner.Design.dll provides the base classes, designers, type converters and type editors that can be used by UIFW control authors. It supports the dynamic loading of UIFW controls into the toolbox, and the dynamic creation of UIFW control types at design-time. It supports the FxDesigner by providing classes that allow visual and text editing, and serialization of FX files, and also multiple end-user device platforms, and multiple form factors.

UxDesigner implements UIFW Controls within Visual Studio. The Controls are defined via metadata files. The metadata files describe the controls. When UxDesigner is loaded by Visual Studio, the metadata is used to generate the control assembly and defines how the controls are loaded into the Visual Studio toolbox and what controls are created at design-time. UIFW provides tools for the UI designer to write and extend metadata for custom controls described previously in §3.1.

When the UIFW project is complete 725 and dugged, emulated, etc. 727, 729, 731, 733, the final phase is to create a user-device run-time application image using the UxDesigner project management tools to parse, compile and link the UIFW components to produce the run-time device application (i.e. OS image for device) as shown ‘in FIG. 7B 735. The UIFW run-time device application will be discussed in further detail in subsequent sections.

4.2 Creating a Layout

Returning to FIG. 7A, a UI designer, having installed the UIFW development environment on their development computer and having the Microsoft Visual Studio open on the desktop uses a custom UIFW wizard and associated wizard library to launch a new UIFW layout project. Running the New Project wizard will produce either a blank or pre-populated UI device design surface on which to place an arrange UI components on. The UI designer uses the toolbox controls to implement a user interface layout for their application.

UIFW follows a document/view paradigm consisting of: Document Data; and the Document View. Document Data is data provided by the FX file. The Document View is composed of two views: the Design View and the Code View.

The Design View is the design surface. The UIFW components are placed on the Design View from the UxDesigner toolbox. The components are drawn after dropping the component onto the design surface. Thus, a UI layout does not require any underlying application logic to be tested, as the elements within a design may be tested independently.

FxDesigner also allows for both the code view and design view to be open at the same time. Updates in one will affect the other. Code view uses the standard Visual Studio XML editor; this view enables the user to directly edit a skin (i.e. FX) file.

With respect to Design Views, the UIFW allows multiple design views of the same data. FxDesigner provides a Window Frame to host the design surface on which the design view is hosted. The design surface has a root component and a control that represents the View element. The root component creates the View control to present to the user as the designer surface. The View element is specified by the FX file and is the parent of all other elements. The only distinctive quality of the View control is that it is the first control created in the control collection and is therefore the parent to all other components in the design. The same type of root component is created for all types of views. The type of view to create is determined when the factory creates the Document Data object. The size for the view element represented in the design view is dictated by the currently selected form factor. The designer supports deleting and removing components from the design view.

With respect to Document Data, the UIFW application manages FX files using the Document Data class to represent data as it appears in the View represented on the design surface. There is one instance of Document Data for each type of View. The EditorDocumentData class represents the data for a design view as well as for other types of Views.

The EditorHostLoader class is a member of the EditorDocumentData class and is responsible for creating the component structure that represents the data in the FX file. When the DesignerLoader.PerformLoad method is called, the FX file is deserialized. Each element of the FX file is hosted with an ElementHost object. The ElementHost objects are added to the RootComponents component collection. The collection is used to support the design surface.

The EditorHostLoader class manages the control selection on the design surface and in the Properties Window through the ISelectionService. Each component in the component collection is represented in the Properties Window. A property is visible if it has the BrowsableAttribute set to true.

4.3 UxDesigner Toolbox

The UxDesigner toolbox contains numerous toolbox items. Each toolbox item has an associated ElementHost control that is used to construct the user interface. At runtime, ElementHost controls will host runtime elements.

More specifically, the UIFW managed library contains custom code which associates a desired behavior, via software application control, to a particular control. These controls are mapped from the design element to the application code via the design element APIs provided are contained within the managed library. The controls implement the IElementHost interface. The UIFW provides a sample implementation of the interface, ElementHost. The ElementHost class provides the basic implementation to present the UIFW control in the toolbox as well as expose the control's design time behavior by Visual Studio's .NET framework to create control designers, type converters and type editors.

Design objects presented on the design surface are .NET controls hosting both standard Visual Studio and custom UIFW controls. The UxDesigner toolbox facilitates the addition or removal of design time specific features by specifying a different Designer from a set of Designers for UX Control authors. Type converters are used to convert specialized data types into strings and back, and the UIFW application development environment provides a set of type converters for UX Control authors. A set of type editors are also provided that allow users to change the design time properties of complex UI components.

Referring to FIG. 6, the components utilized by the UIFW are shown. Specifically, with respect to the UxDesigner toolbox, it contains both UIFW Specific Controls and Windows CE GWES and Windows CE Common Device Controls. Each control can be used to construct the user interface. UIFW Specific Controls have the highest amount of theme awareness while Windows CE GWES and Windows CE Common Device Controls have limited theme awareness.

The toolbox filters all toolbox items such that only those with the ToolboxItemAttribute set to FxDesigner.ToolboxItem are shown in the toolbox. When the UxDesigner is installed and loaded for the first time, the InitializeToolbox method opens all the metadata files in the UxDesignerControls installation directories. A metadata file defines associated control assemblies and the controls to add to the toolbox, and the metadata defines a toolboxitem class for the control.

UxDesigner creates an instance of the toolboxitem class and during the load process place the toolbox item on the toolbox. Duplicate toolbox items will not be allowed within the same toolbox tab. The same toolbox item may be present in different toolbox tabs. Each control will specify the name of the toolbox tab to place its toolbox item using the CategoryTabAttribute on the control class. Each control will specify the name of the toolbox item by specifying the name using the DisplayNameAttribute on the control class. Each control will specify the bitmap to represent the toolbox item by specifying the bitmap using the ToolboxBitmapAttribute on the control class.

The FxDesigner ToolboxItem class is implemented for use by all controls and supports serialization and drag and drop. The ResetToolbox menu item allows the user to reload the toolbox with the controls specified by the metadata files. Removing a metadata file does not immediately remove the control from the toolbox. The item will be removed after closing and reloading UxDesigner, or by calling ResetToolbox. When a UI designer is developing a new control, calling ResetToolbox will force the metadata files to be read. During toolbox loading, when the metadata file is consumed, if a metaclass is invalid, the toolbox item is not created. This prevents the control from being created and being described in the FX file.

4.4 Themes

The UIFW provides tools and libraries to support the creation of themes and visual styles, and the UxDesigner renders these appropriately at design time as well as run time for all controls. By selecting a theme in the UxDesigner toolbar, the UI designer can preview their layout design in the selected theme, and can easily apply new themes to a given layout. Theme DLLs are included with the default install libraries, and a configuration FX file provides the UxDesigner tool with default themes and fonts in which to display FX files.

In particular, and referring to FIG. 6 and others, the UIFW enables the customization of many UI elements that will occur at run-time, such as: system colors; startup and shutdown screens; logos; language; background wall paper; color scheme; welcome text; banner text; user defined shortcut key(s); menu style; screen saver; and icons, to name a few. The creation of a theme starts at build time, where the UIFW adds customizations to many parts of the Windows CE operating system, namely the Windows CE standard controls (i.e. GWES) and the Windows CE common controls (i.e. CommCtrl), and through the addition of new UIFW specific controls. These custom controls are then used at run-time by the UIFW Theme Manager to apply and manage a theme on the end-user device.

More specifically, the UIFW provides code that changes the appearance of the Windows CE standard controls (GWES), namely Button (push, radio, check, groupbox), Combo Box, List Box, Scrollbar, and Static, and uses the Theme Manager to control the colors and resources used to draw the controls. Similarly, the UIFW provides code that changes the appearance of the Windows CE common controls (CommCtrl) Header, Progress bar, Tab control, Toolbar, Trackbar, and Up-down control.

Specific custom UIFW controls which are specifically designed to be used with portable electronic devices, such as wireless phones, are provided. Many of these controls provide support for a device which does not have a mouse or touch screen, or has very few hardware keys.

Theme implementation for an UIFW end-user device includes various customization techniques specific to a particular device hardware platform. Implementation of themes occurs in two phases: during UI design layout and build-time, and during run-time on the end-user device.

Build time theme customization usually occurs as design requirements for a specific ‘look and feel’ provided to the UI designer in a design time theme manager referred to as FxThemes. The UI designer will then implement these requirements using the UIFW development environment design tools including UxDesigner and FxThemes, to create a run-time theme for use and deployment on the customer's device.

For example, an OEM cellular phone manufacturer may require that on start-up a specific corporate branded screen containing the corporate trademark and sound bite appears. In addition, the OEM's network operator customers may require that the default background screen containing a network specific branded screen will be displayed as the default background screen after the OEM start-up screen. Typically, themes developed for OEMs and network operators are characterized as being non-overrideable (e.g. startup logos, shut down logos, startup sound, etc.), and necessitate customizations for the common controls library (e.g. Windows CE CommCtrls). OEMs and network operators will provide the necessary theme based resource attribute files to be compiled into BFX format and distributed on the end-user device run-time application image.

It should be noted that the UIFW can be designed to provide multiple concurrent theme support on the end-user device, thus facilitating the implementation of context and environmentally sensitive displays. Additionally, specific themes may, at design time, be created for each application deployed on the end-user device. For instance, an application which launches a web browser may have a specific theme associated with it, and another application, such as a camera application, may be associated with an alternate theme.

At run-time, themes on the end-user device the UIFW Theme Manager operates to display one or more themes available on the end-user device, which may include default themes (i.e. those supplied by the OEM and network operator), as well as any additional themes the end-user may have applied using the Theme Manager tool. The Theme Manager loads and displays a screen theme, based on the theme based files referencing various theme based resources like attribute files in BFX format, images, sound and video files, as per their specified format. Theme Manager is an application to select, manage and customize the available themes.

More specifically, FxThemes provides theme definitions for the UI controls provided with the UIFW application development platform. FxThemes provides a set of libraries, reference layouts, custom element and component models, and schema definitions in the form of Reference Themes. Several Reference Themes are included, e.g., a ‘Blue Theme’ and a ‘Green Theme’ which includes a proposed theme using a default set of colors as implied by the name, as well as element and component positions for a standard size display for a cellular phone. There are reference libraries for specific visual display hardware platforms which pre-define the specific width, height and size of display text and graphics, by selecting the appropriate Reference Themes as a starting point. The UI designer can quickly alter a Reference Theme to facilitate the rapid development of complex graphical user interfaces for specific device platforms.

FxThemes also contain an extendable API interface for extending the standard Win32 system for handling colors and metrics. The FxThemes API provides Themed attribute values or fallback to default values if not set such that if default theme values are not available the respective theme based application can handle the situation gracefully without catastrophic system error. While FxThemes is a thin layer on top of the Windows CE GWES layer when retrieving colors, it extends the Window CE APIs when it comes to retrieving themed images, icons, sounds, and animations. FxThemes packages place the most commonly utilized controls and components of the UIFW into reference layouts which can be rapidly altered during both design and run times. FxThemes provides a standard set of APIs which are used for applications implementing themes on the end-user device.

FxThemes is only an application layer that provides themeable attribute data to the applications via the published APIs. At build time these APIs are bound to the underlying Application Engine Model. FxThemes assumes that if the requested themeable attribute is not defined by the custom theme, a standard default attribute value is provided that is set at build time. If no default value is provided the API respond with no value found and application needs to provide its own set of default values for the respective themeable attribute, thus ensuring all controls provided on the end-user device platform adhere to a common Theme and are enforced across the platform.

To ensure themes are uniformly applied at run-time, FxThemes employs Customized Control Hooking. Via the Skinning Engine and Theme Manager, it provides custom drawing code which overrides the default implementation of common controls that are loaded at runtime. This includes the owner drawn controls of the default UI controls provided with the device hardware platform. The UIFW run-time application for the end-user device platform includes a Theme Manager Application and Control Panel applet that manages and installs new themes, uninstalls existing themes, customizes current theme and enumerates themes. The UIFW device side Theme Manager is presented further in subsequent sections.

5. UIFW Device Specific Components

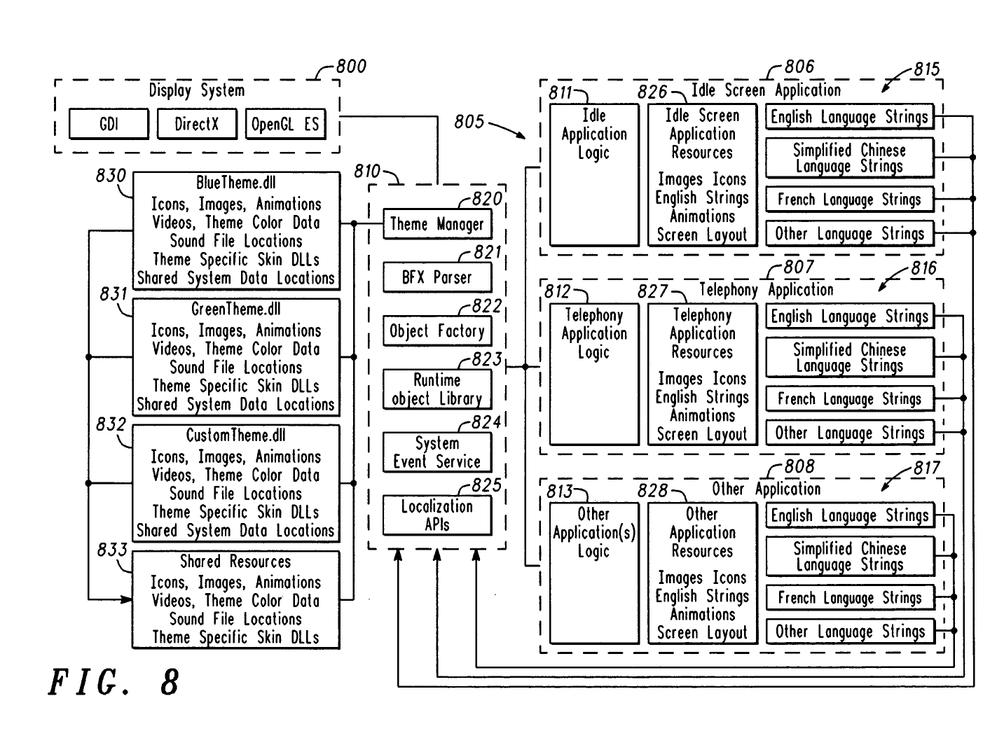

Referring to FIG. 8, the device specific UIFW components are shown. The Display System 800 is the device specific hardware and associated software on/for which the various UI layouts will be presented. It consists of the hardware and software required for the specific end-user device platform, as defined by the device manufacturer. The UIFW contains an abstraction layer that allows UI elements to target different UI rendering technologies, such as GDI, DirectX or OpenGL ES.

As specified by the manufacturer, one or more Applications 805 will be deployed, for which an associated set of UI interfaces will have been defined using the design and build-time UIFW development tools. Examples of such software applications are indicated in FIG. 8 by the separate software applications shown as ‘Idle Screen Application’ 806, ‘Telephony Application’ 807, and ‘Other Application’ 808; where these examples are exemplary only and not restrictive to the specific type of application with which the UIFW may be utilized. Each Application will include the Application Logic (i.e. Application Logic Model 811, 812, 813, respectively, controls UI behavior responsive, e.g., to user or device generated events), and Application Resources 826, 827, 828 (i.e. images, icons, strings, layouts as separate entities) and Languages 815, 816, 817, respectively, that will be used to create the Application specific screens.

In one or more embodiment, the UIFW Run-time Skinning Engine 810 can be comprised of: a Theme Manager 820; BFX Parser 821; Object Factory 822; Runtime Object Library 823; System Event Service 824; and Localization APIs 825, all of which have been previously described in the context of their build-time deployment. Custom Themes (e.g., Blue Theme 830, Green Theme 831, Custom Theme 832), as well as any shared system resources (i.e. Shared Resources 833) that were defined at build-time. The UIFW Run-time Skinning Engine 810 uses these resources and components to deploy and manage user interfaces for the applications deployed on the end-user device as further discussed and described.

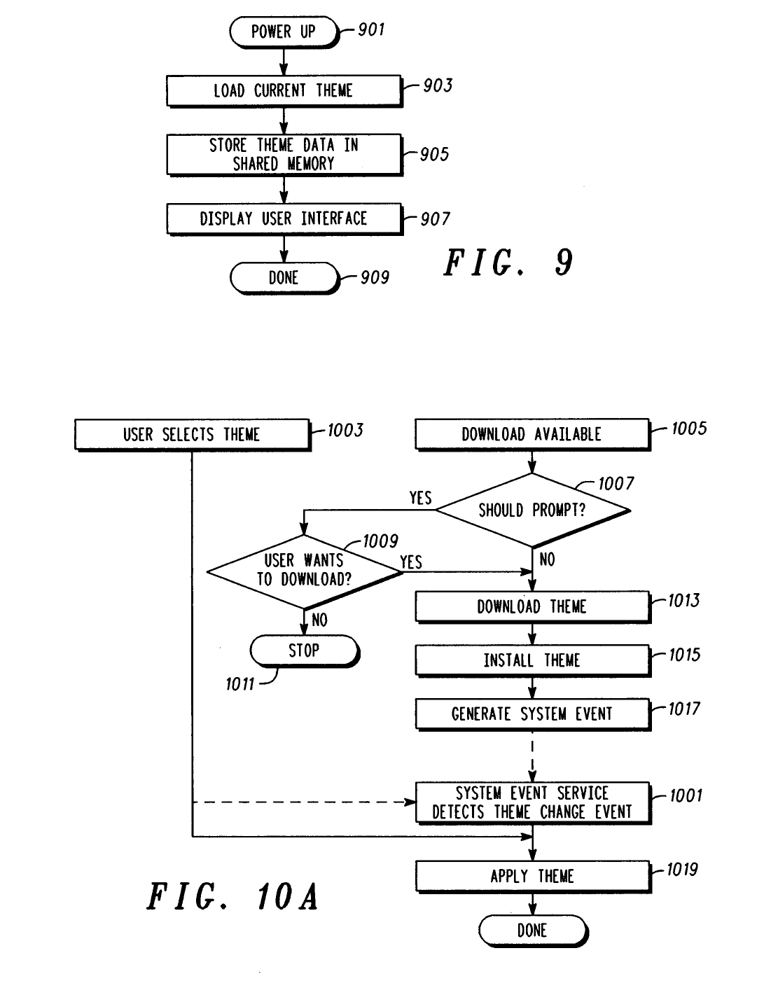

Referring additionally to FIG. 9, on start-up (i.e. Power Up 901) the UIFW Skinning Engine 810 loads the Theme Manager 820. The Theme Manager loads the Current Theme 903 for the first defined application, e.g., the idle screen application. Every system must contain at least one Theme, and each Application has at least one Theme associated with it (this may be a system default theme for all Applications). A Theme contains one or more of the following; icons, images, animations, videos, color data, sound file locations, image files locations, theme specific skin DLLs, and shared system data locations. For a given application, normally all associated or related screens use the same theme. When the theme changes, the appearance of all application related screens change. Shared system data is available for use by multiple screens and applications and includes: icons, images, animations, videos, color data, sound file locations, and image files locations

The BFX Parser 821 is then used to open BFX data contained in resource only DLLs or stored separately and iterate over the data structures contained in the data. The Object Factory 822 then uses the BFX Parser to read BFX files and, based on the tokens returned by the parser, runtime objects are created and their properties are set. Since runtime objects represent user interface elements, this enables the Object Factory 822 to create windows, controls, and other screen elements from BFX skin files.

Similarly, the Theme Manager 820 also uses the BFX Parser to parse theme data and create structured theme data in a region of memory, which in some embodiments can be shared by all processes in the system 905. By creating the theme data in shared memory the Theme Manager is able to reduce RAM requirements and increase performance. Also, the organization of the theme data allows nearly instantaneous theme changes. Given the data, a user interface can be rendered 907 and the power up process of FIG. 9 ends 909, but may be repeated as needed.

The Runtime Object Library 823 contains the machine code implementations of the objects that are used by UIFW applications. These objects have a consistent mechanism for setting and getting properties that allows them to be created by the Object Factory.

The System Event Service 824 controls the order in which competing events are handled and user interface notifications of differing priorities are shown. When user interface notifications arrive, the highest priority notification is shown first. If a higher priority notification arrives later the current notification is removed from the screen and re-queued to be shown later. If a lower priority notification arrives later it is queued up to be shown after all higher priority notifications have been handled.

The Localization APIs 825 enable the device user to change the user interface language for the device on demand without restarting the device. In order to achieve this, user interface language strings are separated from the skin layout. When the language changes all applications are notified. Language strings that are managed by the framework are automatically updated with the new language. If an application manages its' own user interface strings, it must handle the language change notification and update it's strings and UI if necessary. This may be necessary for strings that require formatting at runtime.

Thus a user interface framework (UIFW) application that is arranged and configured to facilitate rendering a display on an electronic device, where the user interface framework application is stored in a computer readable medium (e.g., memory of an electronic device or other media) includes a skin file having features and screen layout information, with the skin file associated with an application. The UIFW application further includes a theme file, which is separate and independent from the skin file, and which includes screen theme information associated with the application, and a skinning engine coupled to the skin file and the theme file and configured to provide data to facilitate the rendering the display in accordance with the skin file and the theme file.

In further aspects, the UIFW application includes a skin file that further comprises application logic, application resources (including in some embodiments, separate layout and skin data), and language strings, one or more specific to the application, wherein the application logic, application resources, and language strings are separated from each other. The theme file can further comprise shared system data locations where screen theme data that can be shared with other processes is located.

The UIFW application in other embodiments includes a parser and a theme manager, where the theme manager uses the parser to create structured theme data based on the theme file. The UIFW application in varying embodiments, upon start-up, employs the theme manager using the parser to create a current structured theme data based on a current theme file corresponding to a current application. The structured theme data can be stored in shared memory at a shared system data location specified in the theme file.

In various embodiments, the UIFW application, specifically the skinning engine can further comprises a parser which is configured to open the skin file and parse data structures contained therein. The skinning engine can further comprises an object factory configured to create runtime objects responsive to the data structures as parsed by the parser and to set properties for the runtime objects, with the run time objects representing screen elements. In still other embodiments, the UIFW application further comprises a system event service configured to control the order of servicing competing events, each of the competing events corresponding to a unique rendering of the display.

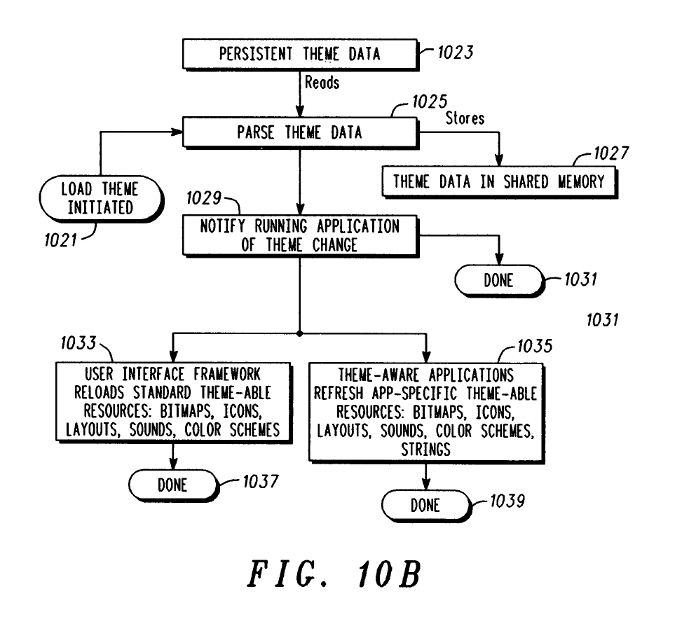

The UIFW also supports event driven changes of Theme data as shown with reference to FIG. 10A. Once running, the UIFW System Event Service monitors the system for requests to change the Theme, shown as ‘System Event Service detects Theme Change Event’ 1001. A common request to change a theme is from the end-user if they specifically select a new theme, shown as ‘User Selects Theme’ 1003. Event-driven theme changes may happen automatically, as is shown when ‘User Selects Theme’ proceeds directly to the process ‘Apply Theme’ (shown in more detail in FIG. 10B). In other situations, a device manufacturer or carrier may choose to change a theme in response to device driven events such as GPS location, data-connectivity availability, near field communications events, receiving a message, receiving a phone call, etc.

The user can be prompted to accept theme downloads prior to a theme change. This process begins with ‘Download Available’ 1005. The Theme Manager may or may not contain specific logic which requires the user to be prompted prior to beginning a theme download; this is indicated by the decision ‘Should prompt?’ 1007. For example, the device may receive advertisements for new themes over a data-connection. The bearer may be SMS, WiFi, WiMAX, NFC, Ethernet, Bluetooth, IRDA, Zigbee, or any other valid data signal. When theme availability is advertised changes may happen automatically or the user may be prompted to accept theme changes. Depending on the specific application logic, downloading a new theme may require acknowledging receipt of the theme or making a payment to unlock the DRM rights for theme content This requires a decision step ‘User wants to download?’ 1009. If the end-user declines, the download process is terminated 1011. If the end-user accepts, the Theme is downloaded 1013, installed 1015 and applied 1019 (generate systems event 1017, detect event 1001) as indicated by the remaining process blocks.

In FIG. 10B, the ‘Apply Theme’ 1019 process is initiated with the ‘Load Theme’ request 1021 from the running application. Note, this request may originate from any running application via the Theme Manager API. In the event that the System Event Service receives a request to change it will use the Theme Manager API to enact the theme change. It may be any type of request to load the theme data and is not restricted to a user or system download of a new theme. FIG. 10B, shows the processes involved in applying all theme data. The process begins with the request to apply theme data. The BFX Parser determines which theme to obtain from the persistent data store ‘Persistent Theme Data’, e.g., responsive to the user selected theme or downloaded theme, parses the theme data 1025, then stores the theme data in shared memory (i.e. RAM) 1027 for the use of all applications running within the UIFW. Next, all running applications are notified, via inter-process notification mechanisms, that a theme change has taken affect 1029 and the notification process is complete 1031. On receipt of the theme change notification, the UIFW reloads all the standard themeable resources (i.e. bitmaps, icons, layouts, sounds, color schemes, etc) causing the new theme to be applied to all UIFW system components 1033. Concurrently, theme aware applications also refresh application specific themeable resources (i.e., bitmaps, icons, layouts, sounds, color schemes, etc) which are specific to that particular application system settings 1035 and the processes end 1037, 1039.

Thus FIGS. 10A and 10B show systems and methods of changing a theme for an electronic device without restarting the device. A method in a user interface framework for changing a theme that is used on an electronic device, comprises obtaining a new theme file, parsing the new theme file to provide theme data, notifying running applications of a theme change, reloading themeable resources with in accordance with the theme data, and refreshing themeable resources associated with applications that are theme aware, wherein the theme that is used on the electronic device for one or more applications is changed without restarting the electronic device. In some embodiments, the obtaining the new theme file further comprises a user selecting a theme and the parsing the new theme file further comprises reading persistent theme data corresponding to the theme. After parsing in some embodiments, the method includes storing the theme data in shared storage, wherein other running processes can access the theme data. The method can include notifying running applications of a change in the theme.

In various embodiments, the obtaining a new theme file further comprises downloading the new theme file and in some instances prompting the user that a new theme file is available for a download and obtaining approval prior to the downloading. The method can include installing the new theme file and in a download or user selected situation, generating a system event. Responsive to detecting the system event, the method includes applying the new theme file, e.g., as noted above. The obtaining the new theme file can comprise obtaining a new theme file that is separate from a skin layout or skin data.

It should be noted, that application of a new theme utilizing the system and methods described herein, does not require the end-user device to re-start or re-boot with the installation and application of a new theme. Theme changes can now be applied in real time without disruption of the end-user's use and experience. The system and methods as described herein, provide mechanisms which facilitate contextual theme management both within the device, and with response to the external operational network environment. Environmentally context sensitive theme changes on user devices are highly desirable for the purpose of product advertising, marketing and branding, for example displaying team logo information when the user is at a football game, or displaying a fashion designer's brand logo when entering a store. Thus the systems and methods disclosed here facilitate such possibilities. As such, the User Interface Framework is sufficiently flexible and robust at both design and run-time to support data independent user interface designs for portable electronic devices.

It will be appreciated that the above described architectures, components, functions, and methods may be practiced in varying forms including source and object code using conventional computing platforms as well as various devices, including mobile phones, etc. The processes, architectures, systems and methods, discussed above, and the inventive principles thereof are intended to and can alleviate time and effort issues caused by prior art techniques for developing UI applications with custom skin and theme screens and changing such screens for mobile phones and the like. Using these principles of independent layout and data files as well as independent and separate theme and skin files, a given UI application can readily be developed or changed and utilized on a wide variety of devices including phones and the like with relatively minimal costs and the like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A user interface framework application arranged and configured to facilitate rendering a display on an electronic device, the user interface framework application stored in a computer readable medium and comprising:
a skin file including features and screen layout information, the skin file associated with an application;
a theme file, separate from the skin file, and including screen theme information associated with the application, and
a skinning engine coupled to the skin file and the theme file and configured to provide data to facilitate the rendering the display in accordance with the skin file and the theme file.

2. The user interface framework application of claim 1 wherein the skin file further comprises application logic, application resources, and language strings specific to the application, wherein the application logic, application resources, and language strings are separated from each other.

3. The user interface framework application of claim 1 wherein the theme file further comprises shared system data locations where screen theme data that can be shared with other processes is located.

4. The user interface framework application of claim 1 further comprising a parser and a theme manager, the theme manager using the parser to create structured theme data based on the theme file.

5. The user interface framework application of claim 4 wherein, upon start-up the theme manager using the parser to create a current structured theme data based on a current theme file corresponding to a current application.

6. The user interface framework application of claim 4 wherein the structured theme data is stored in shared memory at a shared system data location.

7. The user interface framework application of claim 1 wherein the skinning engine further comprises a parser which is configured to open the skin file and parse data structures contained therein.

8. The user interface framework application of claim 7 wherein the skinning engine further comprises an object factory configured to create runtime objects responsive to the data structures as parsed by the parser and to set properties for the runtime objects, the run time objects representing screen elements.

9. The user interface framework application of claim 7 further comprising a system event service configured to control the order of servicing competing events, each of the competing events corresponding to a unique rendering of the display.

10. A method of designing a user interface framework application which is arranged and configured to facilitate rendering a display on an electronic device, the method comprising:
providing one or more skin files that represent a screen skin for an electronic device;
providing one or more theme files that represent a screen theme for the electronic device;
separately compiling the skin files and the theme files to provide compiled skin files and compiled theme files; and
compiling and linking the compiled skin files with resources to provide an image that when run on the electronic device will facilitate rendering the display in accordance with the skin files and the theme files.

11. The method of claim 10 wherein the providing the one or more skin files further comprises providing skin files for all screens associated with an application on the electronic device.

12. The method of claim 10 wherein the providing the one or more skin files further comprises selecting objects from a menu, editing properties of those objects, and previewing the objects to provide the one or more skin files.

13. The method of claim 12 wherein the objects and properties are defined by an object schema.

14. The method of claim 10 wherein the providing one or more theme files further comprises selecting theme elements, editing the theme elements, and previewing the theme elements.

15. The method of claim 10 further comprising separately validating the compiled skin files and the compiled theme files, prior to compiling and linking the skin files with resources.

16. The method of claim 15 wherein the separately validating the compiled skin files and the compiled theme files, respectively, uses skin schema data included in a schema file and theme schema data included in theme schema file.

17. The method of claim 10 wherein the compiling and linking the compiled skin files to provide an image further provide an image wherein data files are separate from dynamically linked libraries and run time executables.

18. A method performed by a user interface framework application, the method creating a view to facilitate rendering a display of an electronic device where the user interface framework application is installed, the method comprising:
calling one or more functions from a dynamically linked library (DLL);
forming, responsive to the calling, an element factory;
reading separate layout information and data from storage with the element factory; and
creating a plurality of skin objects responsive to the separate layout information and data, wherein the plurality of skin elements are associated with the view to facilitate rendering the display of the electronic device.

19. The method of claim 18 wherein the calling further comprises calling an API which is a set of functions exported from a DLL.

20. The method of claim 18 wherein the reading further comprises registering callbacks with a parser and reading the separate layout information and data using the parser.

21. The method of claim 20 further comprising parsing the separate layout information and data using the parser as the reading occurs and forwarding information to the element factory regarding each element and data attributes of each element.

22. The method of claim 21 wherein the creating a plurality of skin elements further comprises creating a skin element corresponding to each element and setting properties for each skin element using values of the data attributes of each corresponding element.

23. The method of claim 18 further comprising reading theme files from the storage, the theme file separate from the layout information and data, the theme files used for providing a theme for the rendering the display on the electronic device.

24. A method in a user interface framework for changing a theme that is used on an electronic device, the method comprising:
obtaining a new theme file;
parsing the new theme file to provide theme data;
notifying running applications of a theme change;
reloading themeable resources in accordance with the theme data; and
refreshing themeable resources associated with applications that are theme aware,
wherein the theme that is used on the electronic device for one or more applications is changed without restarting the electronic device.

25. The method of claim 24 wherein the obtaining the new theme file further comprises a user selecting a theme and wherein the parsing the new theme file further comprises reading persistent theme data corresponding to the theme.

26. The method of claim 24 further comprising storing the theme data in shared storage, wherein other running processes can access the theme data.

27. The method of claim 24 further comprising notifying running applications of a change in the theme.

28. The method of claim 24 wherein the obtaining a new theme file further comprises downloading the new theme file.

29. The method of claim 28 further comprising prompting the user that a new theme file is available for a download and obtaining approval prior to the downloading.

30. The method of claim 28 further comprising installing the new theme file and generating a system event.

31. The method of claim 30 further comprising detecting the system event and responsive thereto applying the new theme file.

32. The method of claim 24 wherein obtaining the new theme file further comprises obtaining a new theme file that is separate from a skin layout or skin data.
